(19) United States
(12) Patent Application Publication
(10) Pub. No.: US 2021/0335018 A1
(43) Pub. Date: Oct. 28, 2021

(54) DATA GENERATING DEVICE, TRAINING DEVICE, AND DATA GENERATING METHOD

(71) Applicant: Preferred Networks, Inc., Tokyo (JP)

(72) Inventors: Kodai UEYOSHI, Tokyo (JP); Johannes Maximilian KUEHN, Tokyo (JP)

(21) Appl. No.: 17/239,833

(22) Filed: Apr. 26, 2021

(30) Foreign Application Priority Data
Apr. 28, 2020 (JP) 2020-079814

(51) Int. Cl. G06T 9/00; G06T 7/11; G06T 3/60

(52) U.S. Cl. CPC G06T 9/002; G06T 7/11; G06T 2207/20052; G06T 2207/20081; G06T 3/60

(57) ABSTRACT

A data generating device includes at least one memory, and at least one processor configured to perform a data augmentation process on intermediate data before a decompressing process is completed, and generate decompressed data from the intermediate data on which the data augmentation process has been performed.

### CROSS-REFERENCE TO RELATED APPLICATIONS

This application is based upon and claims priority to Japanese Patent Application No. 2020-079814 filed on Apr. 28, 2020, the entire contents of which are incorporated herein by reference.

### BACKGROUND

### 1. Technical Field

The disclosure herein may relate to a data generating device, a training device, and a data generating method.

### 2. Description of the Related Art

A server device that performs data augmentation processes on image data, generates training data, and trains a training model is known. In the server device, for example, if a file compressed in a predetermined manner is processed as image data, the training data is generated and the training model is trained by a central processing unit (CPU) first decompressing the compressed file and generating decompressed data and a dedicated processor (i.e., a training device) subsequently performing data augmentation processing on the decompressed data (or by the CPU performing some of the data augmentation processes on the decompressed data, and the dedicated processor performing remaining data augmentation processes on the decompressed data).

With respect to the above, a process of decompressing compressed files performed by the CPU requires a certain amount of time. Thus, when training of a training model is performed, if training data generated based on compressed files is to be used, the generation of training data becomes a bottleneck, thereby reducing the computational performance during training and limiting the overall performance of the server device.

### SUMMARY

The present disclosure may provide a data generating device, a training device, and a data generating method that improve processing efficiency in generating decompressed data from a compressed file.

According to one aspect of the present disclosure, a data generating device includes at least one memory, and at least one processor configured to perform a data augmentation process on intermediate data before a decompressing process is completed, and generate decompressed data from the intermediate data on which the data augmentation process has been performed.

### BRIEF DESCRIPTION OF THE DRAWINGS

FIG. 1 is a diagram illustrating an example of a hardware configuration of a server device;

FIG. 2 is a diagram for describing an overview of a process of a generic JPEG encoder generating a JPEG file;

FIG. 3 is a diagram for describing an overview of a process of the generic JPEG encoder decompressing the JPEG file and generating decompressed data;

FIG. 4 is a diagram illustrating a functional configuration of a preprocessing core;

FIG. 5 is a diagram illustrating a specific example of a cropping process performed by a cropping unit;

FIG. 6 is a diagram illustrating a specific example of a resizing process performed by a resizing unit;

FIG. 7 is a diagram illustrating a specific example of a flipping process performed by a flipping unit; and

FIG. 8 is a diagram illustrating an execution example of the preprocessing core.

### DETAILED DESCRIPTION

In the following, embodiments of the present disclosure will be described in detail with reference to the accompanying drawings. In the present specification and the drawings, components having substantially the same functional configuration may be referenced by the same reference signs, and the overlapping description is omitted.

### First Embodiment

<Hardware Configuration of a Server Device>

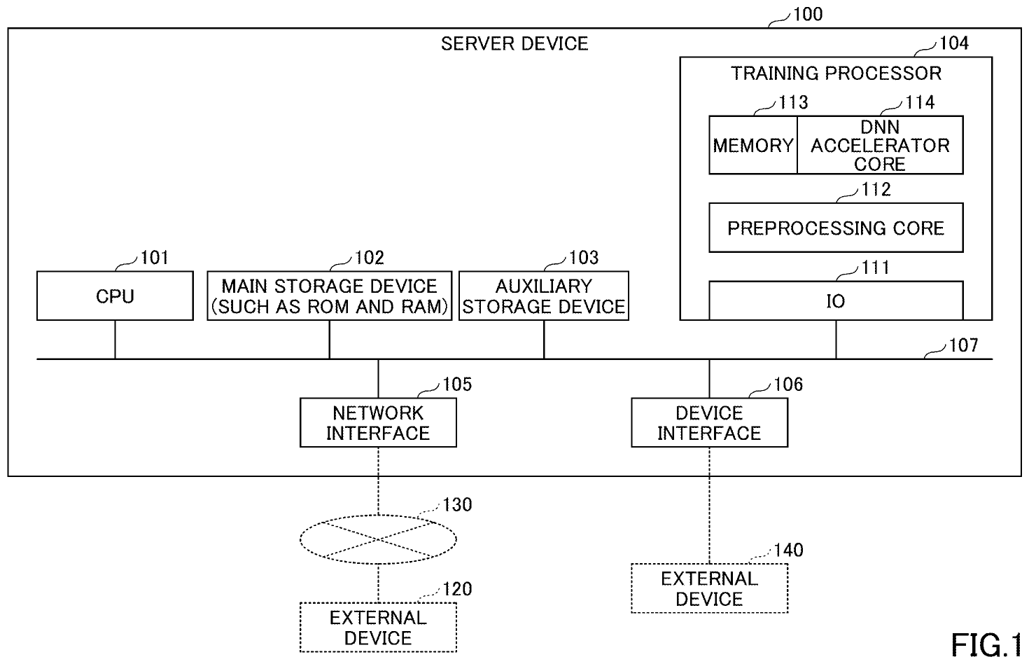

First, a hardware configuration of a server device in which a method of generating data according to a first embodiment is achieved will be described. FIG. 1 is a diagram illustrating an example of the hardware configuration of the server device. As illustrated in FIG. 1, a server device 100 includes, for example, a CPU 101, a main storage device (memory) 102, an auxiliary storage device 103, a training processor 104, a network interface 105, and a device interface 106, as components. The server device 100 may be implemented as a computer in which these components are connected through a bus 107.

In the example illustrated in FIG. 1, the server device 100 is illustrated as having one of each component, but the server device 100 may include multiple units of the same component. In the example of FIG. 1, the single server device 100 is illustrated. However, a distributed computing configuration in which multiple server devices communicate with one another through the network interface 105 or the like to perform overall processing may be used. That is, the server device 100 may be configured as a system that achieves a function by one or more computers executing instructions stored in one or more storage devices. Additionally, a configuration in which various data transmitted from a terminal may be processed by one or more server devices provided on a cloud, and processing results are transmitted to the terminal may be used.

Various operations of the server device 100 may be performed in parallel using one or more training processors 104 or using multiple server devices communicating with one another through a communication network 130. Additionally, the various operations may be assigned to multiple arithmetic cores provided in the training processor 104 and may be performed in parallel. Some or all of the processes, means, and the like of the present disclosure may be performed by an external device 120 provided on a cloud that can communicate with the server device 100 through the communication network 130. As described, the server device 100 may have a configuration of parallel computing performed by one or more computers. In the present embodiment, the distributed processing and the parallel processing are effective in processing multiple image data, for example, and are not intended to perform the distributed processing and the parallel processing on single image data.

Next, each component of the server device 100 will be described. The CPU 101 may be an arithmetic device that executes various programs installed in the auxiliary storage device 103.

The main storage device 102 may be a storage device that stores instructions executed by the CPU 101 and various data, and various data stored in the main storage device 102 may be read by the CPU 101. The auxiliary storage device 103 may be a storage device other than the main storage device 102. These storage devices may indicate any electronic component that can store various data, and may be a semiconductor memory. The semiconductor memory may be either a volatile memory or a non-volatile memory. The storage device that stores various data in the server device 100 may be implemented by the main storage device 102 or the auxiliary storage device 103, or may be implemented by an internal memory incorporated in the CPU 101.

Additionally, the multiple CPUs 101 or the single CPU 101 may be connected (coupled) to the single main storage device 102. The multiple main storage devices 102 may be connected (coupled) to the single CPU 101. If the server device 100 includes at least one main storage device 102 and the multiple CPUs 101 connected (coupled) to the at least one main storage device 102, a configuration in which at least one of the multiple CPUs 101 is connected (coupled) to the at least one main storage device 102 may be included. Additionally, this configuration may be achieved by the main storage device 102 and the CPU 101 included in the multiple server devices 100. Further, a configuration in which the main storage device 102 is integrated into the CPU (e.g., a cache memory including an L1 cache, an L2 cache) may be included.

The training processor 104 is an example of a training device and may be an electronic circuit, such as a processing circuit, processing circuitry, GPU, FPGA, or ASIC. The training processor 104 may be a semiconductor device or the like that includes a dedicated processing circuit. It should be noted that the training processor 104 is not limited to an electronic circuit using electronic logic elements, but may be implemented by an optical circuit using optical logic elements. The training processor 104 may include a computing function based on quantum computing.

The training processor 104 may read a compressed file stored in the auxiliary storage device 103 and may generate decompressed data on which a data expansion process has been performed. The training processor 104 may use the generated decompressed data to train a network, such as a deep neural network (DNN). However, the network trained by the training processor 104 is not limited to the DNN, but may be a network other than the DNN (the same applies hereinafter).

Specifically, the training processor 104 may include an IO 111, a preprocessing core 112, a memory 113, and a DNN accelerator core 114. The IO 111 is an example of an input device. The IC 111 may read a compressed file (in the present embodiment, a JPEG file) stored in the auxiliary storage device 103 through a bus 107 and may input the compressed file to the preprocessing core 112.

The preprocessing core 112 is an example of a data generating device or a generating device, and may perform a decompression process and a data augmentation process on the compressed file to generate decompressed data on which the data augmentation process has been performed. The preprocessing core 112 may output the generated decompressed data as training data and may store the generated decompressed data in the memory 113.

As described above, in the server device 100, decompressed data on which a data augmentation process has been performed may be generated by the preprocessing core 112. Thus, unlike a general server device, decompressed data on which a data augmentation process has been performed can be generated without using the CPU 101. As a result, according to the server device 100, when the training model is trained using training data generated based on the compressed file, a situation, in which the generation of the training data becomes a bottleneck and the performance of the training is reduced, can be avoided. Further, a situation in which the performance of the entire server device 100 is limited can be avoided.

The memory 113 may store the decompressed data, generated by the preprocessing core 112, on which the data augmentation process has been performed.

The DNN accelerator core 114 is an example of an accelerator. The DNN accelerator core 114, for example, runs the DNN and updates DNN weight parameters by the training data stored in the memory 113 being input by a predetermined unit, to perform DNN training (deep learning).

The network interface 105 may be an interface that connects to the communication network 130 by wireless or wired communication. For the network interface 105, an appropriate interface, such as an interface that conforms to an existing communication standard, may be used. Various types of data may be exchanged by the network interface 105 with the external device 120 connected through the communication network 130. Here, the communication network 130 may be any one or a combination of a wide area network (WAN), a local area network (LAN), a personal area network (PAN), and the like, as long as the network is used to exchange information between the computer and the external device 120. One example of the WAN is the Internet, one example of the LAN is IEEE 802.11 and Ethernet (registered trademark), and one example of the PAN is Bluetooth (registered trademark) and near field communication (NFC).

The external device 120 may be a device connected to the computer through the communication network 130. The external device 140 may be a device directly connected to the computer.

The external device 120 or the external device 140 may be an input apparatus, for example. The input apparatus may be, for example, a camera, a microphone, a motion capture, various sensors, a keyboard, a mouse, or a touch panel or the like, and Provides obtained information to the computer. The input apparatus may be, for example, a device including an input unit, a memory, and a processor, such as a personal computer, a tablet terminal, or a smartphone.

Additionally, the external device 120 or the external device 140 may be, for example, an output device. The output device may be, for example, a display device such as a liquid crystal display (LCD), a cathode ray tube (CRT), a plasma display panel (PDP), or an organic electro luminescence (EL) panel, or may be a speaker that outputs voice or the like. It may also be a device including an output unit, a memory, and a processor, such as a personal computer, a tablet terminal, or smartphone.

The external device 120 or the external device 140 may be a storage device (i.e., a memory). For example, the external device 120 may be a storage device such as a network storage, and the external device 140 may be a storage device such as an HDD.

The external device 120 or the external device 140 may be a device having some of the functions of the components of the server device 100. That is, the computer may transmit or receive some or all of processing results of the external device 120 or the external device 140.

<Description of a Compressed File>

Next, the JPEG file will be described as an example of a compressed file processed by the training processor 104. Specifically, a process in which a general JPEG encoder compresses RGB image data and generates a JPEG file, and a process in which a general JPEG decompressor decompresses a JPEG file and outputs decompressed data will be described.

(1) Processing Flow of Creating a JPEG File

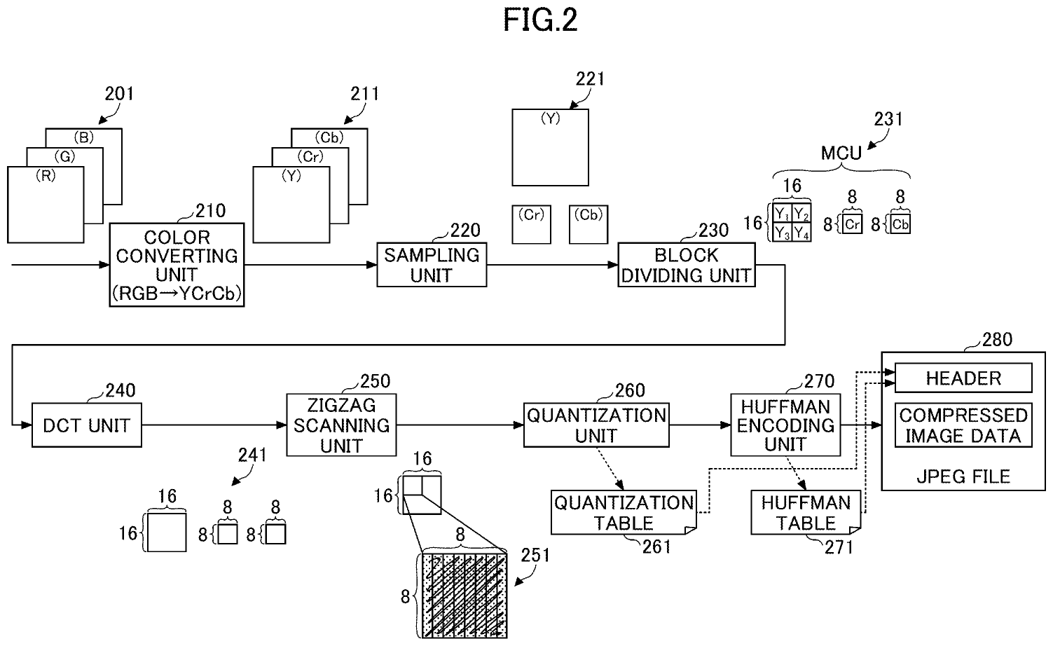

First, a general processing flow in which a JPEG file is generated is described. FIG. 2 is a diagram illustrating an overview of the process in which a general JPEG encoder generates a JPEG file.

As illustrated in FIG. 2, upon RGB image data 201 being input, a color converting unit 210 of the JPEG encoder converts RGB image data 201 into YCrCb image data 211.

Subsequently, a sampling unit 220 of the JPEG encoder samples the YCrCb image data 211. Specifically, in the YCrCb image data 211, the sampling unit 220 does not change brightness information (Y) and downsamples hue information (Cr, Cb) by skipping every other pixel.

Subsequently, a block dividing unit 230 of the JPEG encoder divides the YCrCb image data 221 that has been sampled into blocks having 8 pixels×8 pixels. In the following, the JPEG encoder performs processing by a processing unit of one minimum coded unit (MCU) 231. The MCU 231 includes one block of the hue information (Cr) and one block of the hue information (Cb) for four blocks of the brightness information (Y).

Subsequently, a DCT unit 240 of the JPEG encoder performs the discrete cosine transform (DOT) on respective blocks included in the MCU 231 to generate the MCU 241 on which the DCT has been performed.

Subsequently, a zigzag scanning unit 250 of the JPEG encoder performs zigzag scanning (sequentially scanning for each row) on each block included in the MCU 241 on which the DOT has been performed and aligns data of respective blocks included in the MCU 241 on which the DOT has been performed in a single row (see a reference sign 251).

Subsequently, a quantization unit 260 of the JPEG encoder quantizes the aligned data and generates a quantization table 261. The quantization unit 260 of the JPEG encoder writes the generated quantization table 261 to a header of the JPEG file 280.

Subsequently, a Huffman encoding unit 270 of the JPEG encoder encodes the quantized data by using Huffman encoding to generate compressed image data. The Huffman encoding unit 270 of the JPEG encoder writes the generated compressed image data to a main body of the JPEG file 280. Further, the Huffman encoding unit 270 of the JPEG encoder generates a Huffman table 271 and writes the Huffman table 271 to the header of the JPEG file 280.

The above-described processing performed by the JPEG encoder generates the JPEG file 280.

(2) Processing Flow of Decompressing the JPEG File

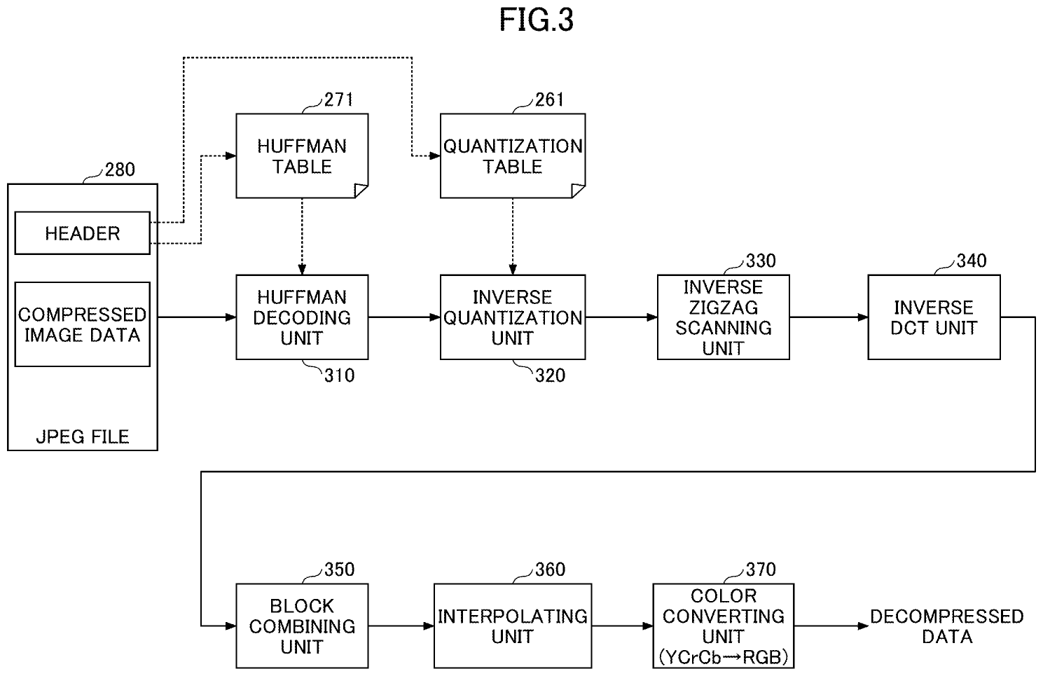

Next, a general processing in which a JPEG file is decompressed to generate decompressed data will be described. FIG. 3 is a diagram for describing an outline of the process in which a general JPEG decoder decompresses a JPEG file to generate decompressed data.

As illustrated in FIG. 3, upon the JPEG file 280 being input, a Huffman decoding unit 310 of the JPEG decoder reads the Huffman table 271 from the header of the JPEG file and performs a Huffman decoding process on the compressed image data.

Subsequently, an inverse quantization unit 320 of the JPEG decoder reads the quantization table 261 from the header of the JPEG file and performs an inverse quantization process on the compressed image data on which the Huffman decoding process has been performed by the Huffman decoding unit 310.

Subsequently, an inverse zigzag scanning unit 330 of the JPEG decoder generates a block of 8 Pixels×8 pixels by performing an inverse zigzag scanning process (by performing a process of arranging data in multiple columns) on the single row of data generated by the inverse quantization unit 320 performing the inverse quantization process.

Subsequently, an inverse DOT unit 340 of the JPEG decoder performs an inverse DCT process on each block in units of MCU.

Subsequently, a block combining unit 350 of the JPEG decoder combines each block on which the inverse DOT process has been performed in units of MCU by the inverse DOT unit 340, to generate the YCrCb image data.

Subsequently, an interpolating unit 360 of the JPEG decoder interpolates the hue information (Cr and Cb) for the YCrCb image data generated by the block combining unit 350.

Subsequently, a color converting unit 370 of the JPEG decoder generates decompressed data by converting the YCrCb image data, in which the hue information (Cr and Cb) has been interpolated by the interpolating unit 360, to the RGB image data.

The above-described processing performed by the JPEG decoder decompresses the JPEG file 280 to generate the decompressed data.

<Functions Achieved in the Preprocessing Core>

Next, functions achieved in the preprocessing core 112 of the training processor 104 will be described. As described above, the preprocessing core 112 may perform a decompression process and a data augmentation process on the compressed file to generate decompressed data on which the data augmentation process has been applied.

At this time, instead of performing the data augmentation process on the decompressed data after the decompression process performed on the compressed file is completed, the preprocessing core 112 may perform the data augmentation process on data (which will be hereinafter referred to as “intermediate data”) generated before the decompression process on the compressed file is completed. That is, the preprocessing core 112 may have a configuration in which a function for the data augmentation process is incorporated between functions of a general JPEG decoder.

Such a configuration enables the preprocessing core 112 to improve processing efficiency in generating decompressed data on which the data augmentation process has been performed, based on the compressed file.

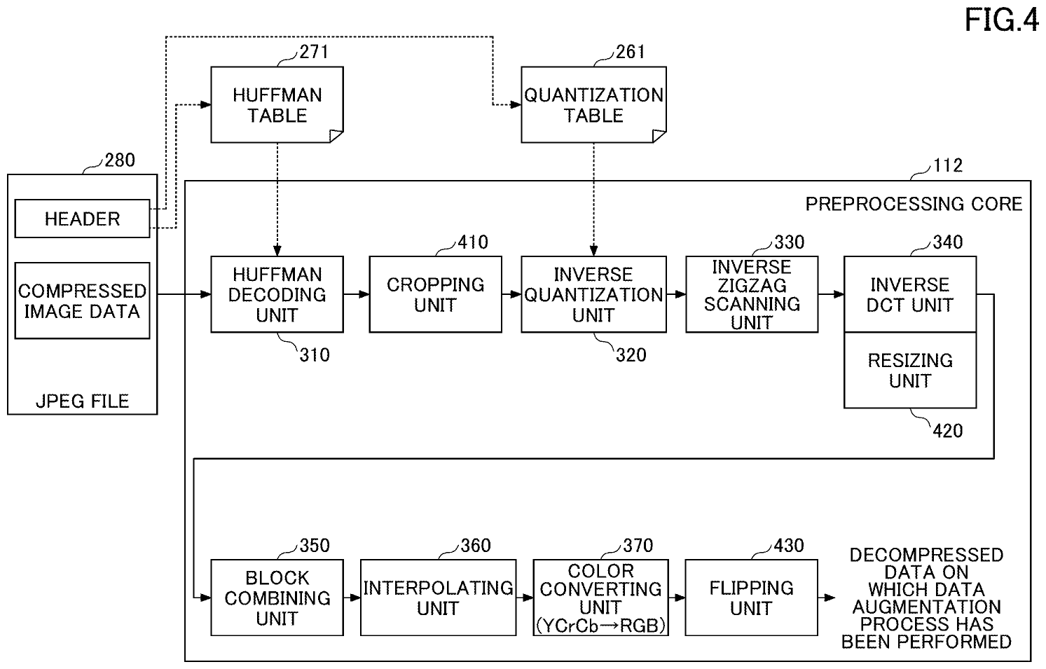

FIG. 4 is a diagram illustrating a functional configuration of the preprocessing core according to the present embodiment. In FIG. 4, the Huffman decoding unit 310, the inverse quantization unit 320, the inverse zigzag scanning unit 330, the inverse DCT unit 340, the block combining unit 350, the interpolating unit 360, and the color converting unit 370 may be the same functions as those included in a general JPEG decoder and have been described with reference to FIG. 3. Thus, the description is omitted here.

The preprocessing core 112 according to the present embodiment may further include a cropping unit 410, a resizing unit 420, and a flipping unit 430 as a manipulating unit (i.e., a manipulating circuit) having a function of the data augmentation process.

The cropping unit 410 may perform cropping manipulation (i.e., a cropping process) to crop a part of the intermediate data generated before the decompression process for the JPEG file is completed. The cropping unit 410 may be disposed at any desired position subsequent to the Huffman decoding unit 310.

Here, if the cropping unit 410 is disposed at an upstream side (i.e., a side close to the Huffman decoding unit 310), each unit located at a downstream side from the cropping unit 410 performs processing on intermediate data of a portion cropped by the cropping unit 410. Therefore, in comparison with a case in which a cropping process is performed on image data on which the decompression process has been completed, the amount of data processed until the decompression process is completed can be reduced, thereby achieving efficient processing. That is, as the cropping unit 410 is disposed at a more upstream side from other units, the reduction effect of the calculation is greater.

If the cropping unit 410 is disposed at an upstream side from the block combining unit 350, the cropping unit 410 may crop the intermediate data in units of blocks. If the cropping unit 410 is disposed at a downstream side from the block combining unit 350, the cropping unit 410 may crop the intermediate data in units of pixels.

The resizing unit 420 may perform resizing manipulation (i.e., a resizing process) to reduce or enlarge the size of the intermediate data. The resizing unit 420 may be disposed at the position of the inverse DCT unit 340, and, in the inverse DCT process performed by the inverse DOT unit 340, for example, the resizing process to reduce the size of the intermediate data is performed by cutting high frequency components. If the size of the intermediate data is reduced due to the resizing process performed by the resizing unit 420, the amount of data subsequently processed is reduced, similarly with the cropping unit 410, thereby achieving the efficient process. However, if the resizing process to reduce the size of the intermediate data is performed, the image quality of the decompressed data generated when the decompression process is completed is reduced in comparison with a case in which the resizing process is not performed by the resizing unit 420.

The resizing unit 420 may perform a resizing process of increasing the size by using, for example, bilinear interpolation or nearest neighbor interpolation, in addition to the resizing process of reducing the size. If the resizing process of increasing the size is performed by using bilinear interpolation or nearest neighbor interpolation, the resizing unit 420 may not be required to be disposed at the position of the inverse DCT unit 340. For example, the resizing unit 420 may be disposed at any desired position subsequent to the inverse DOT unit 340.

The flipping unit 430 may perform flipping manipulation (i.e., a flipping process) of flipping left and right positions of the intermediate data. The flipping unit 430 may be disposed at any desired position subsequent to the inverse DCT unit 340 and may perform the flipping process by reading the intermediate data in a reverse direction. As described above, by performing the flipping process on the intermediate data, the flipping process can be efficiently performed in comparison with a case in which the flipping process is performed on the decompressed data for which the decompression process is completed.

In the preprocessing core 112, in the present embodiment, each unit performing the decompression process that is positioned at a later stage than any of the functions for the data augmentation processing (i.e. any one of a cropping unit 410, a resizing unit 420, or a flipping unit 430) is collectively referred to as a generator or a generating circuit. That is, the generator refers to any unit implemented to perform the decompression process from after the time when any one of the cropping process, the resizing process, or the flipping process is performed on the intermediate data to the time when the decompressed data is generated.

<Specific Example of a Process Using a Function for the Data Augmentation Process>

Next, specific examples of the cropping process performed by the cropping unit 410, the resizing process performed by the resizing unit 420, and the flipping process performed by the flipping unit 430 will be described.

(1) Specific Example of the Cropping Process Performed by the Cropping Unit

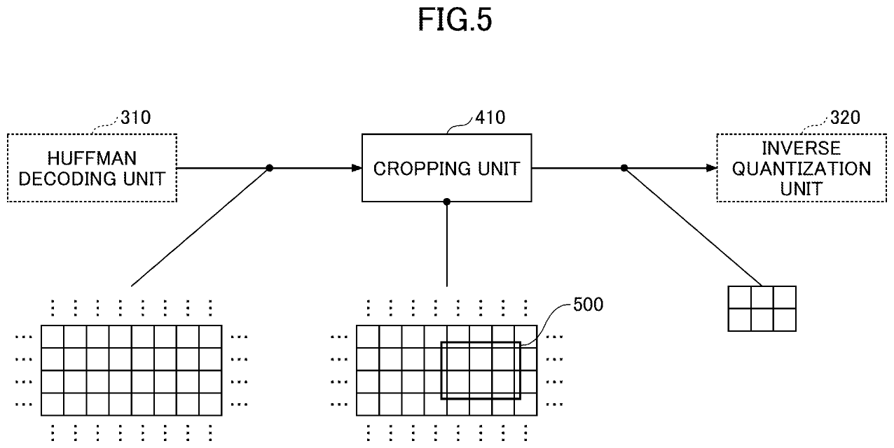

FIG. 5 is a diagram illustrating the specific example of the cropping process performed by the cropping unit. As illustrated in FIG. 5, if the cropping unit 410 is disposed between the Huffman decoding unit 310 and the inverse quantization unit 320, the intermediate data may be input to the cropping unit 410 in units of blocks. Thus, the cropping unit 410 may perform the cropping process by cropping a predetermined number of blocks included in a predetermined area among multiple blocks included in the intermediate data.

The example of FIG. 5 illustrates a state in which the cropping unit 410 crops six blocks included in an area 500. Among multiple blocks, the position of the area to be cropped by the cropping unit 410, the size of the area (i.e., the number of blocks), and the shape of the area may be actually determined by a request from the DNN accelerator core 114 that performs DNN training. However, the position, the size, and the shape of the area are often arbitrarily determined, and in this case, for example, the size of the cropping area may be determined based on a random number.

The cropping unit 410 may perform the cropping process by changing the position of the area to be cropped, the size of the area, and the shape of the area for the single intermediate data and repeating the process multiple times.

(2) Specific Example of the Resize Process Performed by the Resize Control Unit

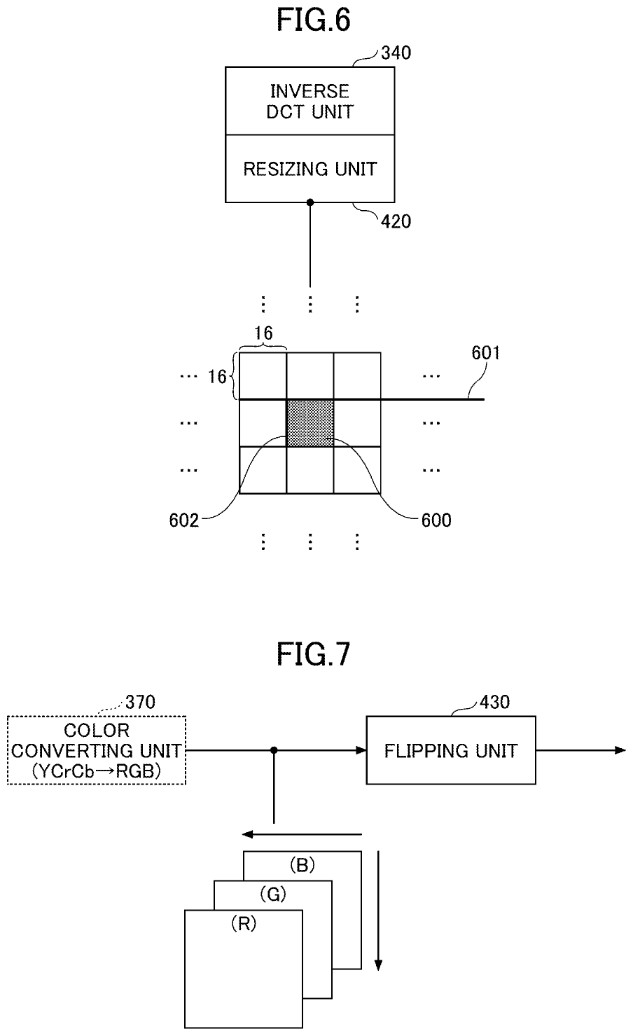

FIG. 6 is a diagram illustrating the specific example of the resizing process performed by the resizing unit, and is a diagram for describing a memory amount used to perform the resizing process to increase the size of the intermediate data. As illustrated in FIG. 6, in the resizing unit 420, when the inverse DCT process is performed by the inverse DOT unit 340, for example, for the brightness information (Y), each 16 pixels×16 pixels block may be sequentially resized. In the example of FIG. 6, a block 600 may be a target block on which the resizing process is to be performed.

If bilinear interpolation or nearest neighbor interpolation is used, when performing the resizing process to increase the size of the block 600, the following blocks may be stored in the memory.

the block 600

a last pixel column (602) of a left block adjacent to the block 600

a last pixel row (601) of an upper block adjacent to the block 600

Therefore, in performing the resizing process to increase the size of the block 600, the following pixels may be stored in the memory.

16 pixels×16 pixels×3 (Y, Cr, Cb)

16 pixels×1 pixel column×3 (Y, Cr, Cb)

1920 pixels (Full HD width)×1 pixel row×3(Y, Cr, Cb)

That is, the resizing unit 420 sequentially may perform the resizing process on each block of 16 pixels×16 pixels by using the memory of 1024 [KB].

As described above, the resizing unit 420 can achieve the resizing process that increases the size of the intermediate data with memory-saving.

(3) Specific Example of the Flipping Process Performed by the Flipping Unit

FIG. 7 is a diagram illustrating the specific example of the flipping process performed by the flipping unit. As illustrated in FIG. 7, if the flipping unit 430 is disposed at a later stage of the color converting unit 370, the RGB image data may be input to the flipping unit 430. At this time, the flipping unit 430 may read each pixel of the RGB image data, for example, in a reverse read direction (i.e., a direction from a pixel on the right end to a pixel on the left end). This enables the flipping unit to reverse the input RGB image data from left to right and output the flipped RGB image data.

<Execution Example of the Preprocessing Core>

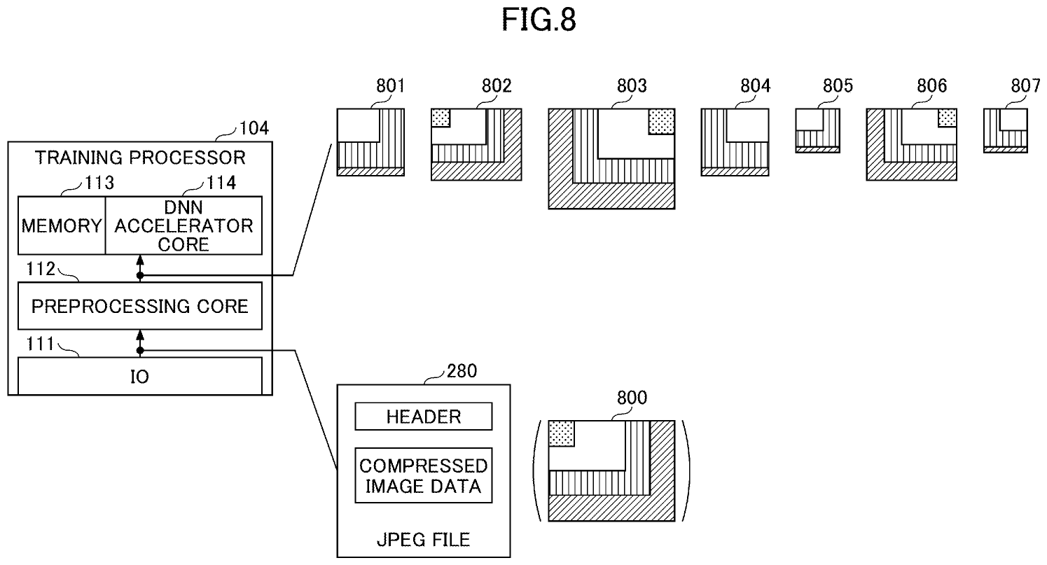

Next, an execution example of the preprocessing core 112 will be described. FIG. 8 is a diagram illustrating an execution example of the preprocessing core. As illustrated in FIG. 8, in response to the IC 111 reading the JPEG file 280 from the auxiliary storage device 103, the preprocessing core 112 may generate decompressed data on which the data augmentation process has been performed. In FIG. 8, the decompressed data 800 illustrates decompressed data generated when the decompression process is performed without the data augmentation process being performed on the JPEG file 280.

With respect to the above, in FIG. 8, decompressed data 801 to 807 are examples of the decompressed data on which the data augmentation process is performed. Among these, the decompressed data 801 on which the data augmentation process has been performed is decompressed data on which the cropping process has been performed by the cropping unit 410 when the JPEG file 280 is decompressed. Specifically, the decompressed data 801 on which the data augmentation process has been performed may be image data corresponding to a portion of the decompressed data 800.

The decompressed data 802 on which the data augmentation process has been performed may be decompressed data on which the resizing process has been performed by the resizing unit 420 to reduce the size when the JPEG file 280 is decompressed. Specifically, the decompressed data 802 on which the data augmentation process has been performed may correspond to image data generated by reducing the decompressed data 800.

The decompressed data 803 on which the data augmentation process has been performed may be decompressed data on which the flipping process is performed by the flipping unit 430 when the JPEG file 280 is decompressed. Specifically, the decompressed data 803 on which the data augmentation process has been performed may correspond to image data generated by reversing the decompressed data 800 from left to right.

The decompressed data 804 on which the data augmentation process has been performed may be decompressed data on which the following processes have been performed when the JPEG file 280 is decompressed.

the cropping process performed by the cropping unit 410

the flipping process performed by the flipping unit 430

Specifically, the decompressed data 804 on which the data augmentation process has been performed may correspond to image data generated by cropping a portion of the decompressed data 800 and reversing the decompressed data 800 from left to right.

The decompressed data 805 on which the data augmentation process has been performed may be decompressed data on which the following processes have been performed when the JPEG file 280 is decompressed.

the cropping process by the cropping unit 410

the resize process to reduce the size performed by the resizing unit 420

Specifically, the decompressed data 805 on which the data augmentation process has been performed may correspond to image data generated by cropping a portion of the decompressed data 800 and reducing the decompressed data 800.

The decompressed data 806 on which the data augmentation process has been performed may be decompressed data on which the following processes have been performed when the JPEG file 280 is decompressed.

the resizing process to reduce the size performed by the resizing unit 420

the flipping process performed by the flipping unit 430

Specifically, the decompressed data 806 on which the data augmentation process has been performed may correspond to image data generated by reducing the decompressed data 800 and reversing decompressed data 800 from left to right.

The decompressed data 807 on which the data augmentation process has been performed may be decompressed data on which the following processes have been performed when the JPEG file 280 is decompressed.

the cropping process performed by the cropping unit 410

the resizing process to reduce the size performed by the resizing unit 420

the flipping process performed by the flipping unit 430

Specifically, the decompressed data 807 on which the data augmentation process has been performed may correspond to image data generated by cropping a portion of the decompressed data 800, reducing the size of the cropped data, and reversing the reduced data from left to right.

As described above, the preprocessing core 112 may perform the data augmentation process when decompressing the JPEG file 280. Therefore, in comparison with a case in which the data augmentation process is performed after the decompression process for the JPEG file is completed, the processing efficiency in generating the decompressed data on which the data augmentation process has been performed can be improved.

### SUMMARY

As is obvious from the above description, the server device 100 may be configured such that the preprocessing core (i.e., the data generating device) is provided in the training processor (i.e., the training device) to generate the decompressed data on which the data augmentation process has been performed at the preprocessing core without using the CPU. In this case, the preprocessing core (i.e., the data generating device) may be configured to manipulate the intermediate data before the completion of decompression in decompressing the JPEG file and generate decompressed data from the manipulated intermediate data, instead of performing the data augmentation process after the decompression process for the JPEG file is completed.

Therefore, the preprocessing core (i.e., the data generating device) according to the first embodiment can improve the processing efficiency in generating the decompressed data from the compressed file.

Additionally, the training processor (i.e., the training device) according to the first embodiment may be configured such that the following components are provided so as to train the training model by using the decompressed data on which the data augmentation process has been performed.

an IO device (i.e., an input device) that reads a compressed file

a preprocessing core (i.e., a generation device) that manipulates the intermediate data before the completion of decompression and generates decompressed data from the manipulated intermediate data when decompressing the JPEG file

a DNN accelerator core (i.e., an accelerator) that runs the deep neural network in response to the generated decompressed data being input

Therefore, the training processor (i.e., the training device) according to the first embodiment can improve the processing efficiency in generating the decompressed data from the compressed file, and can perform training of the training model by using the generated decompressed data.

### Second Embodiment

In the first embodiment described above, the description assumes that the preprocessing core 112 is provided to the training processor 104. However, the preprocessing core 112 may be provided as a device separate from the training processor 104.

In the first embodiment described above, a memory layout (i.e., the order of a number (N), a channel (C), height (H), and width (W)), used when the decompressed data generated by the preprocessing core 112, on which the data augmentation process has been performed, is used as the training data, has not particularly been mentioned.

However, when the decompressed data generated by the preprocessing core 112, on which the data augmentation process has been performed, is used as the training data, the decompressed data may be reordered in a memory layout suitable for training. For example, the CPU 101 may execute the reordering. In this case, the preprocessing core 112 may be configured to output decompressed data in an output format in accordance with an input format of the DNN accelerator core 114. The preprocessing core 112 can control any memory layout because the generated data is output in a stream (i.e., sequentially). The memory layout may be tightly controlled in the training processor 104. The control of the memory layout may be performed by the CPU 101 as described above, but may be performed by a function directly incorporated in the preprocessing core 112.

In the first embodiment described above, the decompressed data generated by the preprocessing core 112, on which the data augmentation process has been performed, has been described as the training data, but the decompressed data may be used as data for inference. When the decompressed data is used as data for inference, the decompressed data generated by the preprocessing core 112, on which the data augmentation process has been performed, may be directly input to the DNN accelerator core 114 (instead of the memory 113).

In the first embodiment described above, a case in which the JPEG file is used as a compressed file has been described. However, a compressed file other than the JPEG file may be used.

### Other Embodiments

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-bb, and a-a-b-b-c-c. Further, the addition of another element other than the listed elements (i.e., a, b, and c), such as adding d as a-b-c-d, is included.

In the present specification (including the claims), if the expression such as “data as an input”, “based on data”, “according to data”, or “in accordance with data” (including similar expressions) is used, unless otherwise noted, a case in which various data itself is used as an input and a case in which data obtained by processing various data (e.g., data obtained by adding noise, normalized data, and intermediate representation of various data) is used as an input are included. If it is described that any result can be obtained “based on data”, “according to data”, or “in accordance with data”, a case in which the result is obtained based on only the data is included, and a case in which the result is obtained affected by another data other than the data, factors, conditions, and/or states may be included. If it is described that “data is output”, unless otherwise noted, a case in which various data itself is used as an output is included, and a case in which data obtained by processing various data in some way (e.g., data obtained by adding noise, normalized data, and intermediate representation of various data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor or a dedicated arithmetic circuit, a circuit structure of the processor may be implemented so as to actually perform the operation B irrespective of whether the control instruction and the data are actually attached.

In the present specification (including the claims), if a term indicating containing or possessing (e.g., “comprising/including” and “having”) is used, the term is intended as an open-ended term, including an inclusion or possession of an object other than a target object indicated by the object of the term. If the object of the term indicating an inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. The advantage/result is merely an advantage/result that results from the configuration described in the embodiment when various factors, conditions, states, and/or the like are satisfied, and is not necessarily obtained in the claimed invention that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data.

Although the embodiments of the present disclosure have been described in detail above, the present disclosure is not limited to the individual embodiments described above. Various additions, modifications, substitutions, partial deletions, and the like may be made without departing from the conceptual idea and spirit of the invention derived from the contents defined in the claims and the equivalents thereof. For example, in all of the embodiments described above, numerical values or mathematical expressions used for description are presented as an example and are not limited thereto. Additionally, the order of respective operations in the embodiment is presented as an example and is not limited thereto.

What is claimed is:

1. A data generating device, comprising:
at least one memory; and
at least one processor configured to:
perform a data augmentation process on intermediate data before a decompressing process is completed; and
generate decompressed data from the intermediate data on which the data augmentation process has been performed.

2. The data generating device as claimed in claim 1, wherein the at least one processor configured to perform at least one of cropping a portion of the intermediate data, resizing the intermediate data, or flipping the intermediate data.

3. The data generating device as claimed in claim 2, wherein the at least one processor configured to crop the portion of the intermediate data after Huffman decoding.

4. The data generating device as claimed in claim 2, wherein the at least one processor configured to resize the intermediate data when an inverse discrete cosine transform process is performed on the intermediate data.

5. The data generating device as claimed in claim 2, wherein the at least one processor configured to flip the intermediate data after an inverse discrete cosine transform process is performed.

6. The data generating device as claimed in claim 1, wherein the at least one processor configured to perform cropping a portion of the intermediate data before resizing the intermediate data or flipping the intermediate data.

7. The data generating device as claimed in claim 1, wherein the at least one processor configured to perform resizing the intermediate data after an inverse discrete cosine transform process is performed.

8. The data generating device as claimed in claim 7, wherein the resizing is performed by increasing a size of the intermediate data.

9. The data generating device as claimed in claim 2 wherein the cropping is performed on the single intermediate data by changing at least one of a position, a size, or a shape of an area of the intermediate data multiple times.

10. A data generating method, comprising:
performing, by at least one processor, a data augmentation process on intermediate data before a decompressing process is completed; and
generating, by the at least one processor, decompressed data from the intermediate data on which the data augmentation process has been performed.

11. The data generating method as claimed in claim 10, further comprising:
performing, by the at least one processor, at least one of cropping a portion of the intermediate data, resizing the intermediate data, or flipping the intermediate data.

12. The data generating method as claimed in claim 11, further comprising:
cropping, by the at least one processor, the portion of the intermediate data after Huffman decoding.

13. The data generating method as claimed in claim 11, further comprising:
resizing, by the at least one processor, the intermediate data when an inverse discrete cosine transform process is performed on the intermediate data.

14. The data generating method as claimed in claim 11, further comprising:
flipping, by the at least one processor, the intermediate data after an inverse discrete cosine transform process is performed.

15. The data generating method as claimed in claim 10, further comprising:
cropping, by the at least one processor, a portion of the intermediate data before resizing the intermediate data or flipping the intermediate data.

16. The data generating method as claimed in claim 10, further comprising:
resizing, by the at least one processor, the intermediate data after an inverse discrete cosine transform process is performed.

17. The data generating method as claimed in claim 16, wherein the resizing is performed by increasing a size of the intermediate data.

18. The data generating method as claimed in claim 11, wherein a size of a cropping area is determined based on a random number.

19. The data generating method as claimed in claim 11, wherein the cropping is performed on the single intermediate data by changing at least one of a position, a size or a shape of an area of the intermediate data multiple times.

20. A decompression method of decompressing compressed image data, comprising performing a data augmentation process on intermediate image data of the compressed image data during a decompression process of the compressed image data.
